(19) United States
(12) Patent Application Publication
(10) Pub. No.: US 2018/0038229 A1
(43) Pub. Date: Feb. 8, 2018

(54) INLINE POWER GENERATOR

(71) Applicant: SPINERGY PTY LTD, Dry Creek (AU)

(72) Inventors: Peter RUBINSHTEIN, Unley Park (AU); Kevin James SOPER, Hope Valley (AU); Malcolm Frederick LEAHY, Mawson Lakes (AU)

(73) Assignee: SPINERGY PTY LTD, Dry Creek (AU)

(21) Appl. No.: 15/788,337

(22) Filed: Oct. 19, 2017

Related U.S. Application Data
(63) Continuation-in-part of application No. 14/422,157, filed on Feb. 17, 2015, now abandoned.

(30) Foreign Application Priority Data
Aug. 17, 2012 (AU) 2012903553

(51) Int. Cl. F01D 1/02; F01D 15/10

(52) U.S. Cl. CPC F01D 1/02; F01D 15/10; F05D 2220/768; F05B 2240/121

(57) ABSTRACT

An electrical generator, comprising a rotatable impeller locatable within a flow path of a conduit. The impeller is rotated by fluid flowing along said flow path. The impeller comprises a magnetic portion, the generator further including a stator located external of the flow path. The stator generating electrical power in response to rotation of the magnetic portion.

This application is a continuation in part of U.S. patent application Ser. No. 14/422,157, filed on 17 Feb. 2015, which is a national stage entry application of International Application No. PCT/AU2013/000921, filed on 19 Aug. 2013, and which claims priority to Australian Patent Application No. 2012903553, filed on 17 Aug. 2012, wherein the specifications and contents of which are hereby incorporated herein by reference in their entirety.

### BACKGROUND OF THE INVENTION

### Field of the Invention

The present invention relates to the generation of electricity using an inline impeller positioned in a flow path of a conduit, and a stator positioned externally of the flow path.

### Description of the Related Art

Supply systems including water and gas lines are typically provided at pressure to ensure delivery to the end user. Elevated pressures are required for the delivery however such pressures are often not required by the end user. Similarly in facilities for the production or delivery of hydrocarbons such hydrocarbons, whether liquid or gas, are carried through conduits at high pressures. Similarly mine shafts carry compressed air to ventilate the shafts. These supply and production systems require a significant input of energy. There have been proposals to utilize the excess pressure within the fluid and gas lines in an attempt to reduce overall energy costs of the system or to utilize the elevate pressure to provide electrical power for operating ancillary devices.

Furthermore, there are many low pressure pipes or conduits located in domestic and commercial settings that are configured to carry liquids and gases, including rainwater downpipe, ventilation pipes, gas extraction system, and other conduits that are configured to carry fluids or gases therethrough, which could be used for the generation of electricity. Similarly wind energy could be harnessed by aligning a conduit with the direction of flow of the wind.

It is an object of the present invention to harness energy of the flow of fluid in a conduit and to convert this to electrical power, in a manner that alleviates or minimises the problems associated with the prior art or at least provides the public with a useful choice.

### BRIEF SUMMARY OF THE INVENTION

In a broad form of a first aspect the invention provides an electrical power generating apparatus, including a rotatable impeller locatable within a flow path of a conduit, the impeller being rotated by a fluid flowing along said flow path, the impeller comprising a magnetic portion, the apparatus further including a stator for location external to said flow path, said stator generating electrical power in response to rotation of said magnetic portion.

The rotation of the magnets installed in impeller creates a rotating magnetic field. The flux of the magnetic field crosses coils within the stator to generate an electrical current within the stator. In this way electrical power is produced from the kinetic energy of fluid flowing through the conduit. The use of inductive coupling for this purpose has the benefit of providing for the transformation of energy without direct conductivity or the use of a mechanical linkage, with attendant risk of fluid leakage from the conduit.

In one form the impeller is rotatable about an axis of a shaft within said conduit and preferably shaft is co-axial with said fluid flow.

In a second broad form of the first aspect the invention provides an electrical power generator comprising
a coupling, the coupling comprising a tube for connection with a flow path of a fluid conduit,
an impeller comprising blades fixed to a shaft, free ends of the blades carrying magnetic portions
the shaft aligned with the flow path inside the tube, a first and second end of the shaft supported relative to an inside surface of the tube by respective first and second mounting means, and
a stator connected to the outside of tube and so aligned with the magnetic portions, that an electrical current is induced on rotation of the impeller.

The impeller may comprise two or more pairs of opposed blades or alternatively the blades may be otherwise spaced apart to provide for balanced weight distribution on the shaft.

Preferably the blades are curved with a concavity of the blade facing the incoming fluid flow to maximize rotating efficiency.

In one form the apparatus includes a support frame that supports the shaft from an internal surface of the conduit. The impeller may be journalled for rotation about the shaft, with the shaft being stationary, however, preferably the shaft is fixed to the impeller to rotate therewith.

It is preferred that the rotation of the impeller has minimal friction. The apparatus thus preferably comprises two pinpoint bearings one each at a respective end of the shaft. The pinpoint bearings each comprise a conical shaft tip and a support frame bearing part comprising a bearing surface shaped as a conical depression. The shaft is preferably formed of metal, and the shaft tip may be of a different bearing specific metal joined thereto, or perhaps simply the same metal but hardened. The support bearing part is formed of metal and is preferably non-magnetic. The support frame is preferably formed of plastics, and thus the support frame bearing may be in the form of a metal insert secured to the support frame.

The impeller may have a two-fin propeller shape with wide sector fins having an overall round cross sectional profile. The opposite fins may have a magnet core with opposite poles coming to the edge of the fins with a minimal gap between their position in the fins and the conduit's cylindrical wall.

In another form the impeller may have an even number of magnetized blades containing magnetic portion of opposite polarity in opposed blades. It is to be understood throughout this specification that the terms fins and blades is used interchangeably, and have the same meaning.

In another form the apparatus comprises a coupling to connect to an end of the conduit or intermediate of portions of a conduit and includes a passageway for passage of fluid of the flow path of the conduit, most preferably for coaxial connection with the flowpath.

The impeller is preferably mounted for rotation in the passageway of the coupling.

The stator may be free standing or attached to the conduit but is preferably held in place on the coupling.

Preferably a pair of stators is provided and each positioned opposite relative to the other on the outside of the coupling. Depending inter alia on the nature of the electrical output required and the nature of the fluid flow it might be desired to have two or three pairs of stators positioned around the conduit.

Multi-turn coils that have a number of turns and wire thickness may provide the most efficient output voltage and current for power usage and storage. The configuration of these parameters may be varied by one skilled in the art to suit the purpose to which they are to be put.

In one form the conduit is inaccessible to fitting the impeller through a first end thereof and comprises an integral support for a first end of the shaft at a radial center thereof, the conduit being open at a second end for fitting of the impeller and shaft therethrough, and to register the first end of the shaft with the integral support, a fittable support frame is put into place to support the second end of the shaft, said fittable support frame comprising a peripheral snap fit connection complementary to snap fit means at the second end of the conduit, so that the fittable support can be inserted into the second end, aligned with the second end of the shaft and snap fit into place. It will be understood however that the support frames may be secured into place other than by a snap fit means, for example by using an adhesive or a fastener such as a screw.

The impeller may have one set of blades, the set of blades comprising two or more radially extending blades collectively balanced, that are rotated about the same radial plane. Alternatively the impeller may comprise two or more sets of blades spaced axially on the shaft. Where one set of blades is provided then a single stator or more than one preferably pairs of stators will be positioned externally of the conduit aligned with the rotation of the set of blades. It will be understood where there are two or more sets of blades then at least one corresponding stator will be aligned with the position of rotation of the magnetic portions for each set of blades. It will be equally understood that the blades may be staggered along the length of the shaft and not necessarily with blades equally paired, but rather that overall the shaft is balanced when rotated. More than one stator will then be suitably positioned.

The movable impeller may be magnetic itself or may have a magnet fitted thereto. In general parts of the apparatus may be magnetically or electrically charged to generate a magnetic or electromagnetic field. The impeller may be constructed from a magnetic material wherein a first, free edge of the impeller is positively charged and a radially opposite second free edge of the impeller is negatively charged.

A plurality of impellers may be positioned within the flow path and associated with corresponding stators, electrically connected in series or in parallel, depending upon the requirements for the apparatus.

Other shaped impellers are also contemplated without departing from the scope of the invention. For example, the impeller may be shaped like a corkscrew, that is, having a helical shape, with magnets embedded in the vanes of the impeller.

Preferably said conduit is constructed from non-magnetic material so that it does not shield or interfere with the electromagnetic or magnetic field produced by the magnetically charged impeller or the external coil. The conduit may thus be of a plastics material, a cementitious material or a metal such as copper, titanium or other metal known in the art suitable for the fluid that is carried by the conduit. The reader will understand that the energy from the moving impeller is transferred by inductive coupling into the stator which has no moving parts.

The apparatus may have its own moment of inertia or include a flywheel to accumulate kinetic energy of the rotating impeller. This provides a more stable rotation speed and as a result, more stable output voltage from the coils.

In one form the conduit comprises one or more directional baffles that impart helical directionality on the fluid flowing therethrough upstream of the impeller.

The baffles may be made as a separate part or attached along an internal wall of said fluid conduit for rotating the flow of fluid onto the impeller, thereby ensuring that the impeller rotates at maximum velocity, or at least is more responsive in a low flow environment.

The fluid in the pipe would normally run parallel to the axis, however, the inside surface of the coupling may be rifled to impart a rotation to the flow, in the same direction as the impeller rotates to enhance efficiency.

A means of streamlining fluid downstream of said impeller may additionally be positioned within the fluid path to minimize turbulence.

In one form this turbulence may be reduced after passing the impeller, via the shaft support frame, which may be shaped with flat wide radial arms in a helical form, of opposite helicity to the flow induced by the baffles and impeller.

In one form the rotating magnetic impeller repeatedly creates and breaks the magnetic loop inside the stator core with multi-turns winding around the core stem. The edge of impeller or magnetic rotor and corresponding ends of stator core are shaped to provide the maximum magnetic coupling when they are positioned adjacent and opposite each other. This process creates the AC voltage in said coils. After rectification this voltage can charge the attached batteries and capacitors and/or supply power directly to an electronic device.

The electrical power may be used to charge a battery that in turn supplies power to operate low power telemetry systems, electronics or lighting. Alternatively, the power generated by the apparatus can be used directly by other devices wherein regulators and capacitors may be positioned between the apparatus of the present invention and the device. The power may be supplied to a network or an electrical grid or used onsite, for instance in locations remote from the electrical grid. The power may also be stored and used to provide trickle charging for electric or hybrid vehicles, emergency lighting or to provide electricity to critical life saving medical devices.

In one form the apparatus may be installed in smart meters or may be interfaced with power boards or other infrastructure. In another form the invention may be installed in white goods, for instance dishwashers or washing machines, and connected to the digital display to reduce power usage.

The invention is scalable and may be adaptable for different sized pipes and adaptable for different liquid or gas types, pressure levels and flow rates.

The present invention may be interfaced with, and provide power for the operation of, secure water distribution systems. Access to systems software/firmware codes may be over a secure network, with real time monitoring, maintenance and management of the system.

The apparatus may be used at the end of a pipe where liquid/gas comes out at high pressure. In this turbine type of power generator one of the factors of efficiency is the differential pressure between inside and outside volumes creating the highest possible speed of gas/liquid coming out the outlet jets. The apparatus can also be placed at the end of pipes having low-pressure outlets, for instance downpipes on houses and other constructions, toilet water tank, boiler, and dispensing systems.

An electrical appliance docking station may be associated with apparatus for storing said electrical energy and supplying electrical power to appliances docked in said station. Preferably, said docking station accommodates and energizes low voltage electrical appliances, including remote control devices.

It will be understood that the term “fluid” and “fluid flow” is not intended to be limited to liquids, but rather includes both gases and liquids. The fluid flow may be through delivery systems having elevated pressures, such as reticulated water systems, natural gas lines or in compressed air lines within mine shafts or in the delivery or distillation of hydrocarbons. However, the invention is not limited to such systems and may be used in relation to any conduit that has a fluid passing through it, even at low pressure, for instance rainwater downpipes or ventilation shafts or pipes, or specifically in the harnessing of wind power where the conduit is aligned with the direction of wind. Reference is made to water and gas line however the apparatus may be used with respect to a conduit configured to carry any gas or fluid, including but not limited to, natural gas, air, vented air, water, milk, petrol and diesel or other hydrocarbon whether liquid of gas.

A second aspect of the invention could be said to reside in a method of installing an electrical power generator into a fluid flow path, comprising the step fitting the electrical generating apparatus of the first form to a conduit, and the step of connecting an output from the stator to an electrical circuit. It will be understood that any form of the electrical generating apparatus of the first form may be fitted.

It will also be understood that the electrical generating apparatus of the first form may be unitary in construction such as the coupling referred to alternatively it may comprise separate parts that are fitted separately, for example the baffles for imparting helical fluid flow may be inserted separately upstream of the impeller. Furthermore the impeller and support frames may be separately fitted into the existing conduit after cutting the conduit open, closing off the conduit and then fitting the stator to the outside of the conduit, and connecting the conduit to and electrical circuit.

In a third aspect the invention could be said to reside in a method of generating electrical power from an apparatus of the first aspect of the invention by flowing fluid through a conduit to which the apparatus of first aspect of the invention has been fitted, and drawing electrical power from the electrical circuit to which the apparatus has been connected. The electrical circuit can encompass any one or more of the indicated uses for this invention described above, from a localized use, for example a metering device, perhaps of the flow of gas, or water through a conduit, to a local light installation to assist with inspection, or more broadly for connection and powering of a local facility, or it may be connected to a network including a plurality of like electrical power generators, or more broadly to an electricity grid.

### BRIEF DESCRIPTION OF THE DRAWINGS

The accompanying drawings, which are incorporated in and constitute a part of this specification, illustrate implementations of the invention and, together with the description, serve to explain the advantages and principles of the invention. In the drawings,

FIG. 1 is a schematic perspective view of a first embodiment of the apparatus of the present invention;

FIG. 2 is a schematic view of a second embodiment of the apparatus;

FIG. 3 is a side view of second embodiment of the impeller used in the apparatus of the present invention;

FIG. 4 is a schematic perspective view of a third embodiment of the apparatus;

FIG. 5 is an end schematic view of a fourth embodiment of the apparatus;

FIG. 6 is an enlargement of the shaft engaging the support member of FIG. 4;

FIG. 7 is a perspective view of the shaft and shaft support frame with inserted bearing bush and impeller of FIG. 4;

FIG. 8 is a rendered cross sectional view of a fifth embodiment of the invention in the form of a coupling, but not showing the stator;

FIG. 9 is a perspective view from an outlet end of the fifth embodiment of the invention, without the stator and without the impeller;

FIG. 10 is a perspective view from an inlet end of the fifth embodiment, showing the position of the baffles mounted at the inlet end;

FIG. 11 is a perspective view of a first form of impeller for use with fifth embodiment having a single set of blades;

FIG. 12 is a perspective view of a second form of impeller for use with the fifth embodiment having two axially spaced sets of impeller blades;

FIG. 13 is a side view of the generator apparatus from the outside of the conduit showing a first embodiment of the manner in which a stator may be fitted to the conduit;

FIG. 14 is a cross sectional view through the conduit of the embodiment illustrated in FIG. 13;

FIG. 15 is a perspective view of embodiment of present invention as shown in FIG. 8;

FIG. 16 is a perspective view as shown in FIG. 15 without the outer casing;

FIG. 17 is the view of FIG. 16 showing only the baffle housing;

FIG. 18 is a front end view of the baffle housing from FIG. 17;

FIG. 19 is a rear end view of the baffle housing of FIG. 17;

FIG. 20 is a cross section view of the baffle housing of FIG. 18 through A-A;

FIG. 21 is a cross section view of the baffle housing of FIG. 17 through B-B; and

FIG. 22 is a cross sectional view of the present invention as shown in FIG. 15 through C-C.

### DETAILED DESCRIPTION OF THE INVENTION

There are numerous specific details set forth in the following description. However, from the disclosure, it will be apparent to those skilled in the art that modifications and/or substitutions may be made without departing from the scope and spirit of the invention. In some circumstance specific details may have been omitted or enlarged so as not to obscure the invention. Similar reference characters indicate corresponding parts throughout the drawings.

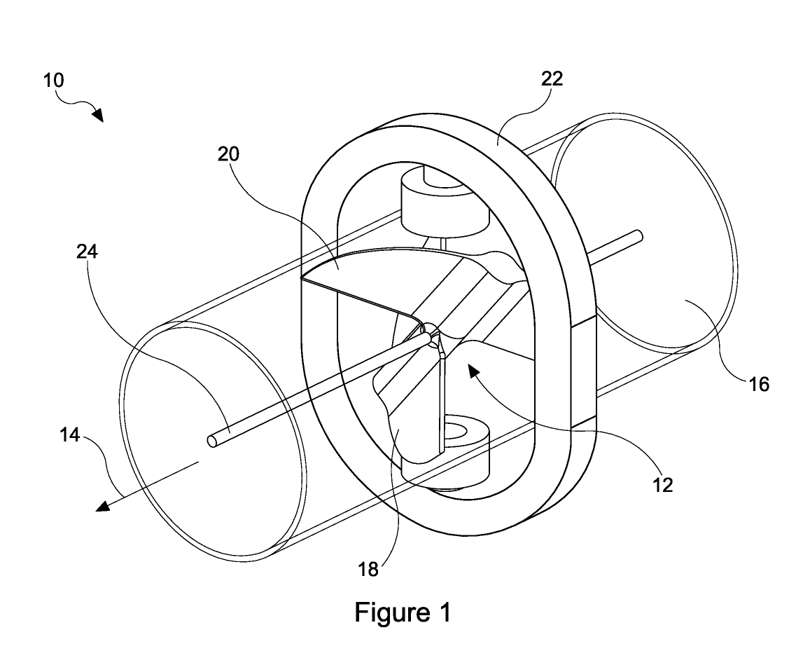

Turning to the figures for a detailed explanation of the invention, there is illustrated a power generating apparatus 10 demonstrating, by way of examples, arrangements in which the principles of the present invention may be employed. As illustrated in FIG. 1 the power generating apparatus 10, includes a rotatable impeller 12 locatable within the flow path 14 of the conduit 16. The conduit may be a pressurized water (or other liquid) pipe or gas line. The vanes or fins 18, 20 of the impeller 12 are oppositely charged as indicated by the N and S in FIG. 1. The fins may have a magnetic core with opposite poles coming to the edges of the fin with a minimal gap with conduit's cylindrical wall.

The apparatus further includes a stator or coil 22 external to the flow path 14 for generating an electrical current in response to the movement of the impeller 12, thereby generating power that can be used immediately, or stored in a connected battery.

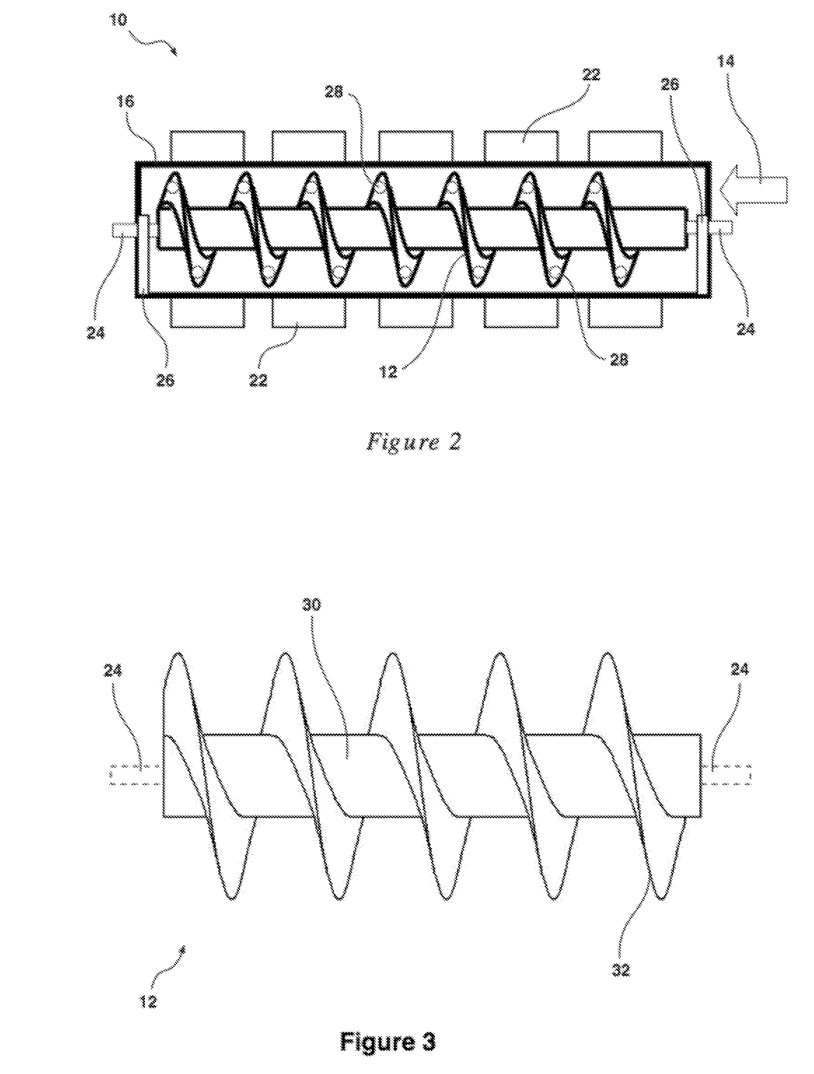

As further illustrated in FIG. 1 the impeller 12 rotatably engages a shaft 24 supported inside the conduit 16. The shaft 24 in another embodiment, as illustrated in FIG. 2, is co-axial with the conduit 16 and is connected to a support frame 26 that is attached to the conduit 16.

A plurality of impellers may be positioned within the flow path and associated with corresponding stators or coils. Alternatively, as illustrated in FIGS. 2 and 3, the impeller 12 may be of a cork screw type configurations, that is helical, and include a plurality of magnets 28 attached thereto. The impeller includes a body 30 and continuous fin 32 that wraps around the body 30 in corkscrew, or helical fashion. The apparatus 10 of the present embodiment includes a plurality of coils 22 external to the conduit. The plurality of coils 22 being in series or in parallel, depending upon the requirements of the apparatus.

The rotating impeller 12 thereby repeatedly creates and breaks the magnetic loop inside the stator core with multi-turns winding around a core stem. The edge of impeller and corresponding ends of stator core are shaped to provide an opposite magnetic coupling when they are positioned adjacent each other. This helically wound fin is not preferred because of the large cross sectional area presented to the flow path that does not transform energy of the flowing fluid into rotation of the impeller, as well as the tendency of fluid exiting to be highly turbulent.

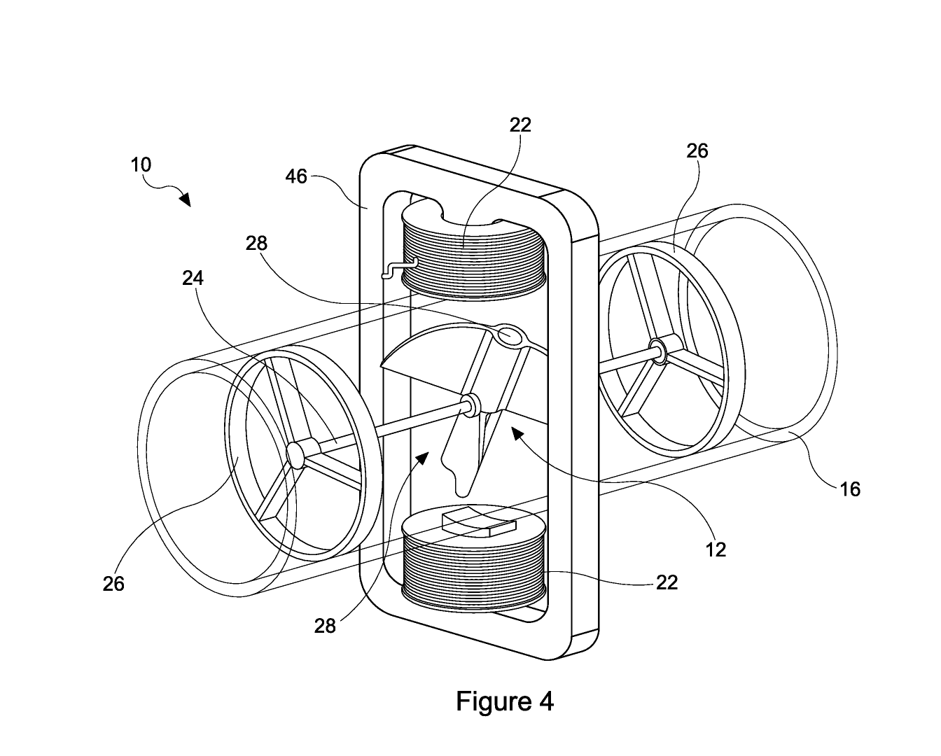

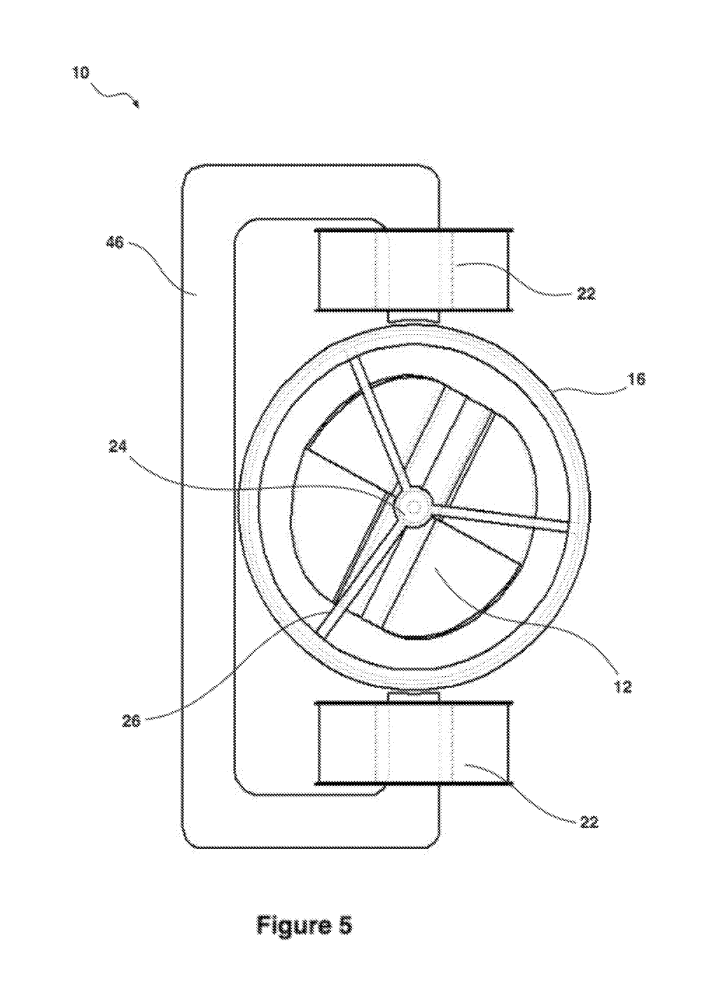

In another embodiment as illustrated in FIG. 4 the coils 22 are attached to a mount 46 that surrounds the conduit 16. The shaft 24 is fixedly attached to the impeller 12 and rotatably engages two support frames 26. As further illustrated in FIG. 5 magnets 28 are located in the opposite ends of the impeller 12.

The support frames 26 may be fixed to the internal wall 42 of the fluid conduit 16, or frictionally engage the internal wall 42.

In still another embodiment, as illustrated in FIG. 5 the mount 46 extends to one side of the conduit 16.

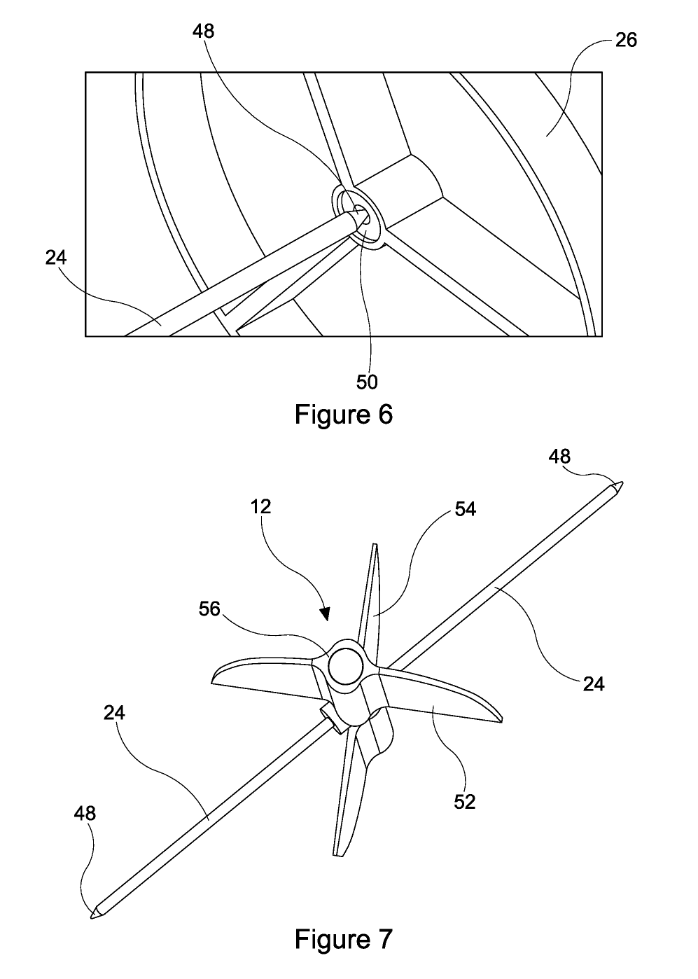

FIGS. 6 and 7 illustrate one possible configuration of the shaft 24, impeller 12 and support frame 26. In the present embodiment the opposite ends 48 of the shaft 24 are tapered and configured to engage bearing surface 50 in respective support frames 26. In this way the shaft 24 rotatably engages the support frame 26 when installed within the conduit 16. It will be understood that this form of engagement provides for a very low friction bearing and is particularly suited for low flow environments. Typically the shaft tip 48 may be a hardened metal whereas the bearing surface that is fashioned into an inverted cone depression may be made of a softer accommodating metal and choices of these will be well know to those skilled in the art of making and supplying bearings. Preferably the metal is non-magnetic. It will also be appreciated that the shaft is quite thin, and again this assists in low flow environments because fluid bearing on the cross sectional dimension of the shaft does not work to rotate the impeller, additionally it means that the weight of the impeller is kept down so that initiation of rotation is facilitated.

The support frames are preferably made of plastics and the support frame bearing is of metal. The support frame bearing is thus inserted into the support frame as can best be seen in FIG. 6.

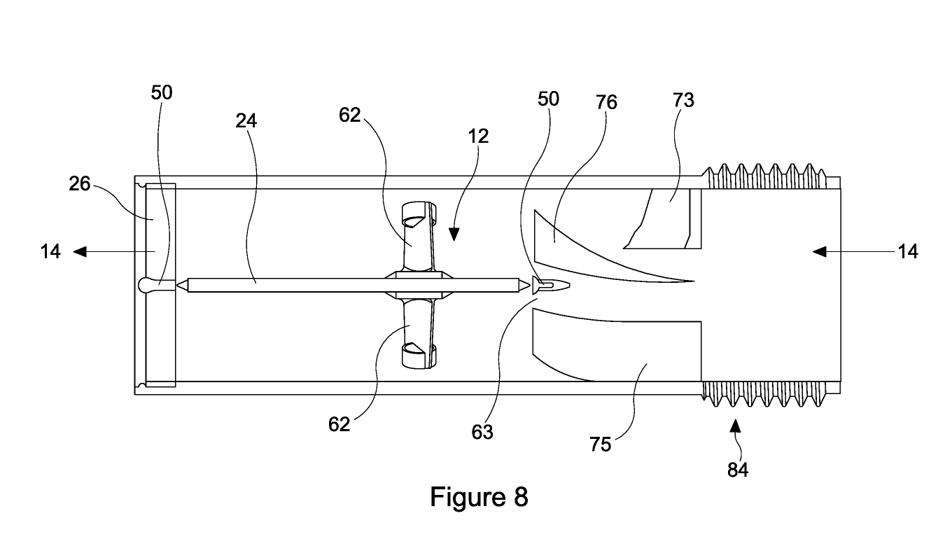

As further illustrated in FIG. 8 the impeller 12 includes vanes 52, 54. The outer ends of the vanes include apertures 56 for accommodating respective magnets therein.

The apparatus 10 may include a flywheel (not shown) to accumulate kinetic energy of the rotating impeller 12. This provides a more stable rotation speed and as a result, more stable output voltage from coils. This may not be all that desirable particularly in low flow environments because this increases the threshold for initiating rotation of the impeller.

Multi-turn coils may have a number of turns and wire thickness, which will provide the most efficient output voltage and current for power usage and storage.

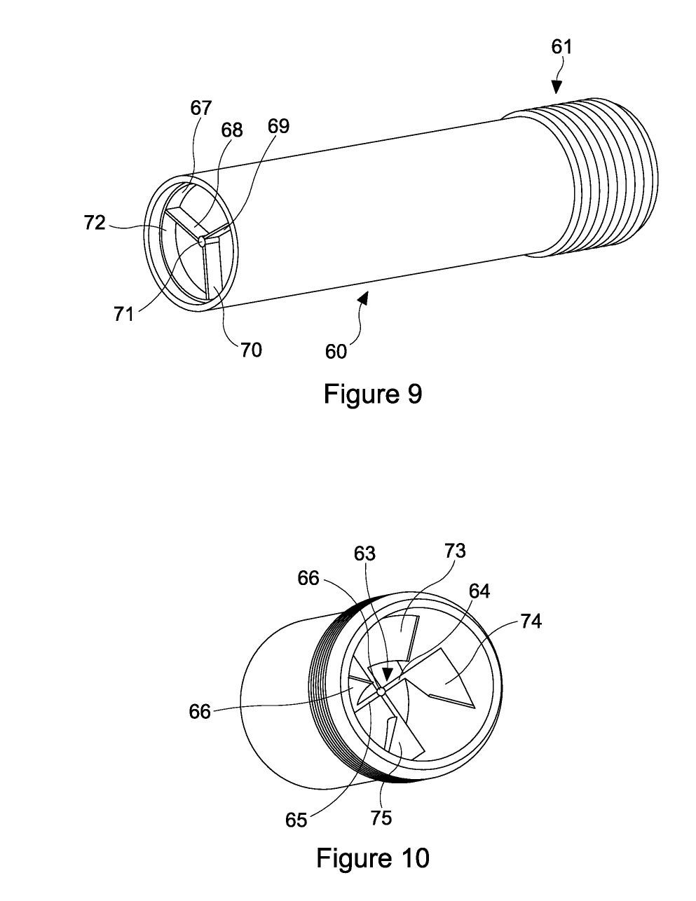

A fifth embodiment of the invention is more particularly shown in FIGS. 8, 9 and 10. this embodiment is in the form of a coupling 60 that might be screwed, via a first threaded end 61 onto a fitting at the end of a conduit such as a faucet connected to a domestic reticulated water supply. The flow path 14 continues on from the faucet through the coupling and end at the other end.

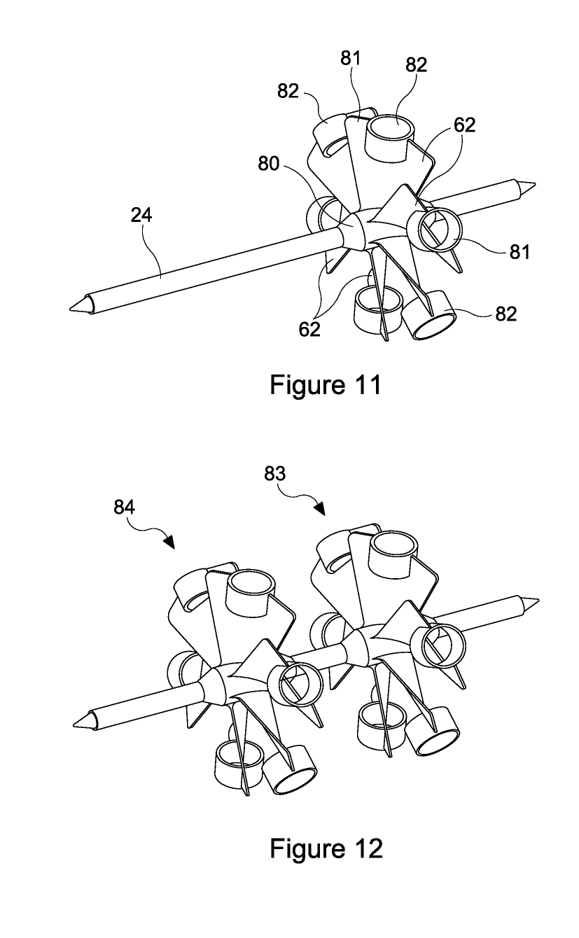

The impeller 12 comprises a plurality of blades 62, best seen in FIGS. 11 and 12, each extending radially from shaft 24. Each of the blades comprises a magnet carrier at a free end, a magnet of suitable polarity can be fastened to the magnet carrier. The blades will be described in more detail below. When magnets are attached they are held in close proximity to the internal surface of the coupling. An outwardly facing surface of the magnets is preferably curved to complement the internal surface of the coupling. The shaft is supported in alignment with the fluid flow and centered radially of the generally cylindrical coupling.

The coupling has a fixed shaft support frame 63 upstream of the impeller, being proximal to a first end of the coupling. The fixed shaft support framed is integrally formed with the coupling. The fixed support frame comprises two crossed stays 64, 65 that cross diametrically across the flow path forming a first central bearing locating hub 66. A first end of the shaft is supported for rotation by the fixed shaft support frame. A second end of the shaft is supported for rotation by a fittable support frame 67. The fittable support frame comprises three radial members 68, 69, 70 extending from a second central bearing locating hub 71. A circumferential flange 72 snap fits into the second end of the coupling. The three radial members are shown as being straight, it will be appreciated however that it is preferable that they have some curve to allow for flexing of the circumferential flange to assist with the snap fit.

Details of the bearing arrangements of the shaft are similar to those shown in FIG. 6. Metal support frame bearings 50 are fitted into the fixed shaft support frame and the fittable support frame.

Perhaps best seen in FIG. 10 are four baffles 73, 74, 75, 76 that are angled and curved relative to the flow path to impart rotation thereon to facilitate rotation of the impeller.

FIG. 11 shows a first form of impeller for use with the fifth embodiment of the invention. The impeller includes six blades 62 that extend radially from a hub 80 of the shaft. The six blades could be considered as three pairs of opposing and balanced blades, such that when considered collectively the set of blades are balanced such that rotation of the impeller is balanced and therefore vibration in minimized. Free ends 81 of each of the blades includes a magnet carrier 82. Magnets may be adhered to all of the carriers, or alternatively just two opposing carrier, or two pairs of opposing carriers, again to provide for a balance in the impeller. The number of magnets carried will depend on the configuration of the stators on the outside of the coupling and this will depend on a number of parameters including flow rate and what the electrical output is to be used for.

FIG. 12 shows a second form of impeller that could be used in the fifth embodiment of the invention. This second form of impeller is essentially the same as the first form except that there are provided two sets 83 and 84 of blades. This might be particularly where it is important to transform more of the energy of the fluid flow into rotational energy of the impeller.

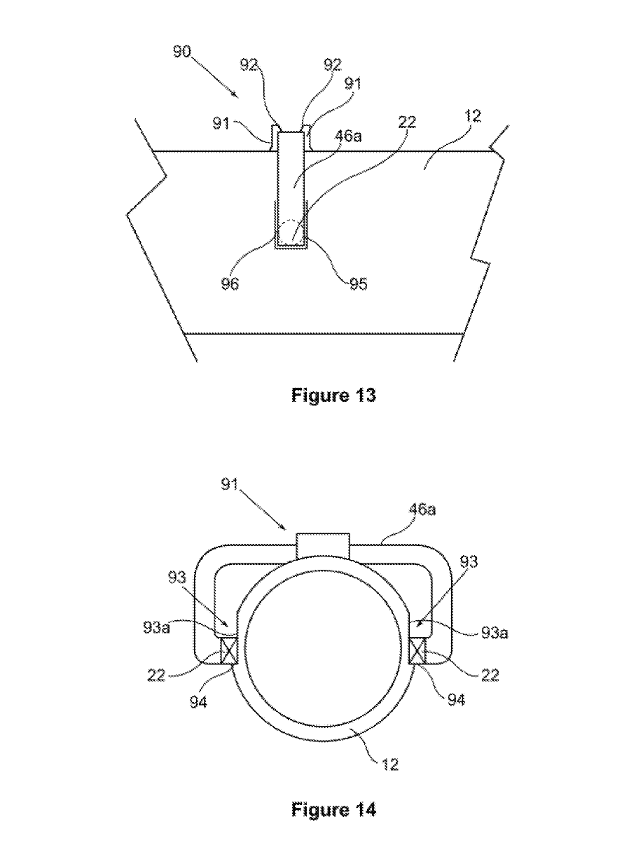

FIGS. 13 and 14 show the way in which the stator may be fitted to the outside of the conduit 12. It will be appreciated that generally it is desirable to fix the stator to the conduit, and where the invention encompasses a coupling such as for example illustrated in FIGS. 8, 9 and 10 it is preferred that the coupling comprises a means to affix the stator 46 to the coupling in a quick and precise manner.

This embodiment shows a C shaped stator armature 46, comprising two coils 22. The coupling has a clip 90 comprising two wings 91 that are integrally moulded into the top of the coupling. The two wings define a groove therebetween and comprise an elongate protrusion 92 at a free end of the wings, providing for a snap fit to capture the top of the stator. Sides of the coupling provide for register 93 for a respective one of the coils. Both registers comprise a flat 93a in the wall of the coupling, and as can be seen a thinning of the wall, bringing the coils closer to the magnets of the impeller. At the bottom of the flat of the register is a land 94. In FIG. 14 the lands are shown as upwardly facing. In FIG. 13 it can be seen that the flat is the bottom of a recess, thus sides 95, 96 of the recess closely fit to sides of the coils 22.

It will be appreciated therefore that when the stator is fitted the coils are in contact with the lands whilst the snap fit of the upper part of the stator within the wings keeps the stator firmly in place.

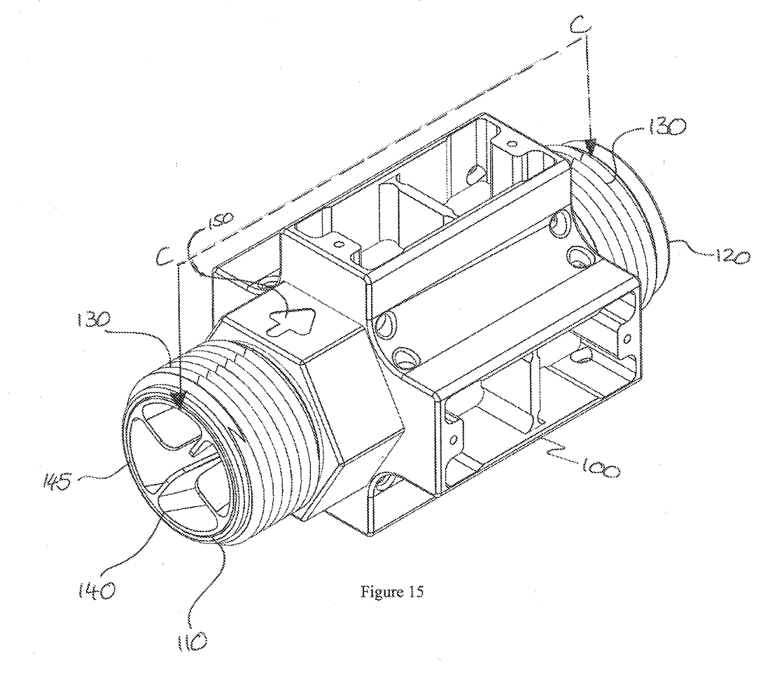

FIG. 15 shows the present invention in a housing similar to that as shown in FIG. 8, In which there is a body 100, having an inlet side 110 and an outlet side 120, both the inlet side and the outlet side having a threaded connection means 130 for connecting to a source of water by way of a suitable threaded connection.

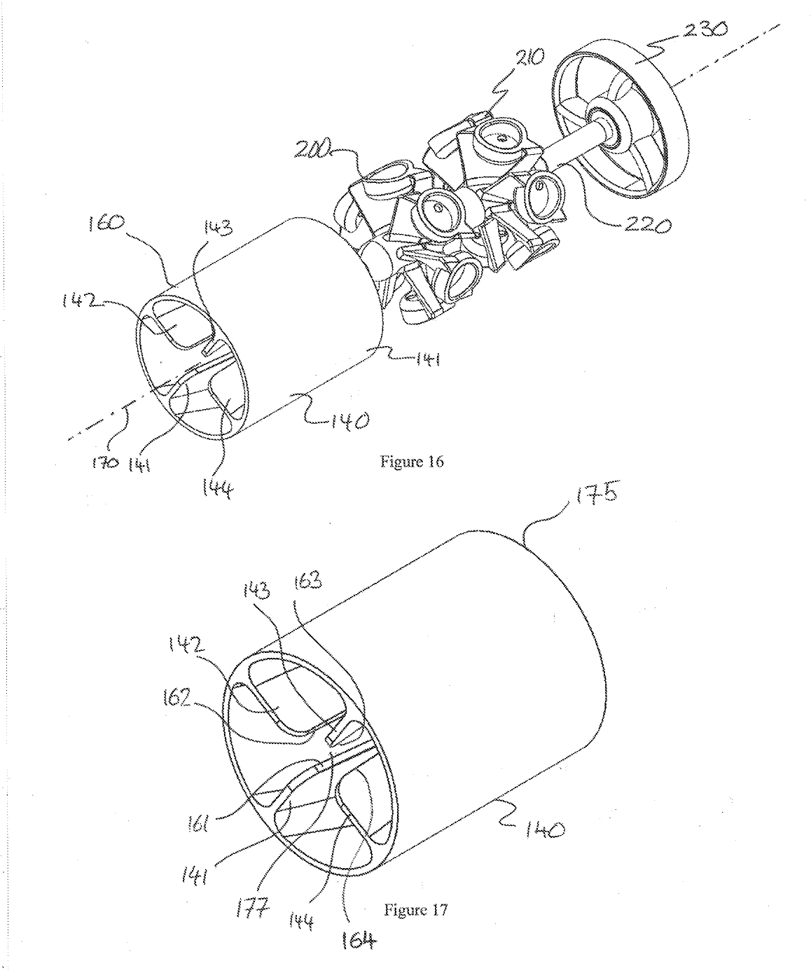

At the inlet side 110 there is located a baffle section 140, located upstream of the impeller blades (not shown in FIG. 15), as indicated by the flow direction arrow 150. FIG. 16 is the same as FIG. 15 but with the outer housing 100 removed in order to show the orientation of the impeller blades 200 and 210, shaft and 220 and the rear shaft support 230, which is positioned close to the outlet side 120. The baffle section 140 now clearly be seen and has an outer peripheral surface 141 that nests within the inner opening 145 the inlet port 111 on the inlet side 110.

On a front end 160 of the baffle 140 there is arranged a number of directional baffles 141-144, each being located 90° with respect to one another about the axis 170. Each of the directional baffles 141-144 extend only partially towards the axis 170 such that each direction before 141-144 as an inner facing edge 161-164 which extends downstream through the center of the baffle section 140 in a helical manner towards the rear end 175 to create a central void region 177.

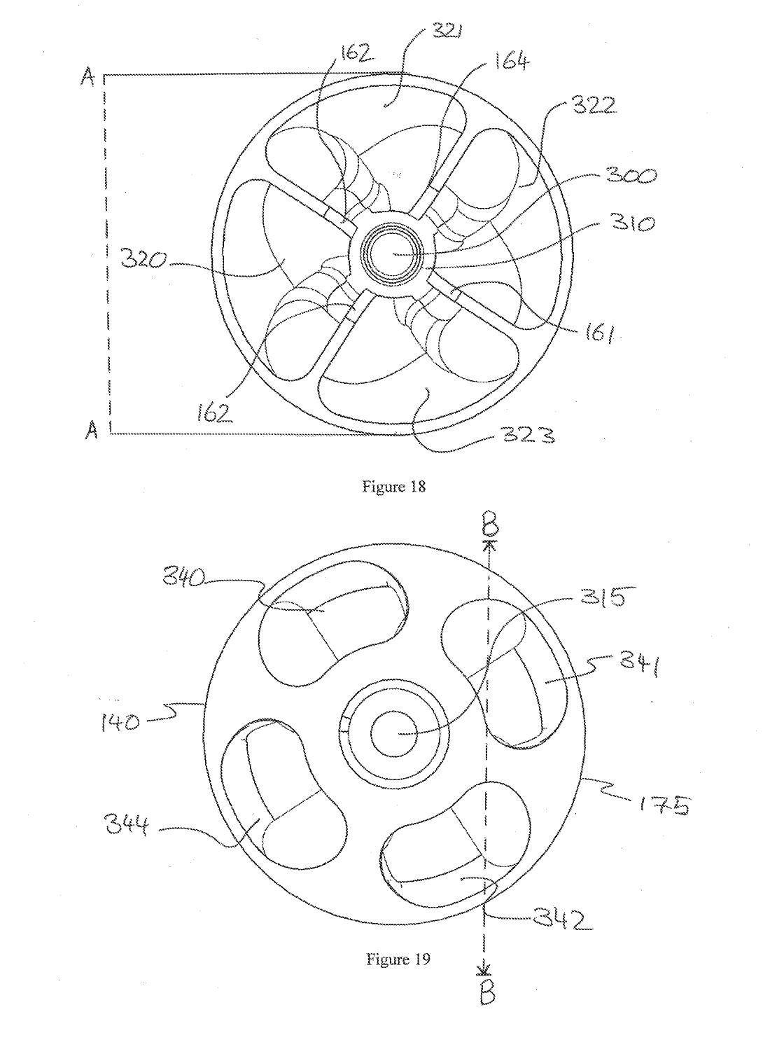

As shown in FIG. 18, being a frontal view of the baffle section 140, there is a central hub 300, which is located towards the rear end 175, and extending inwardly from the outer peripheral edge are the 4 helically arranged directional baffles 141-144, helically orientated towards the central hub 300 and the flange section 310. The front openings 320-323 are respectively positioned between the directional baffles 141-144 at the front end 160, each of the openings 320-323 are the same size. The rearview of the baffle section 140 is shown in FIG. 19 with the rear openings 340-343, position offset relative to the openings 320-323 on the front end 160. Each of the rear openings are sized to be smaller than their respective front openings positioned on the front-end 160 so that liquid passing through the baffle section 140 is forced to pass through a smaller opening, to provide a Venturi effect, thus altering the flow rate of the liquid passing through as well as imparting a helical twist motion to the liquid so as to more effectively provide drive to the impeller blades 200 and 210, which are located downstream. Also on the rear end 175 is the rear end 315 of the central hub 300, which acts as a front shaft support. The rear end 315 is shaped to receive a front end of the shaft 220 and altered in place in conjunction with the rear shaft support 230.

Advantageously, the baffle section 140 can be customized so as to provide baffles with varying degrees of helical slope or pitch and also varying sizes of front openings and rear openings in order to match particular flow rates from a liquid source. For example, in some instances the source of liquid may have a flow rate that is substantially greater than that which is required to drive the impeller blades in an effective/efficient manner in order to generate electricity. Whilst in other instances the flow rate may be closer to that which is theoretically deemed efficient and therefore front and rear openings may be closer to one another in terms of size. Similarly, the degree of helical slope or pitch may also be changed for faster moving water/liquid, for example make less than that used for slower moving liquids, as the flow rate of the water may be sufficient to efficiently drive the impellers with only minor helical twisting of the liquid required. As can be seeing therefore, the present invention provides the ability to more efficiently and accurately tailor the flow of water/liquid relative to the optimal angle/speed required to drive the impellers downstream.

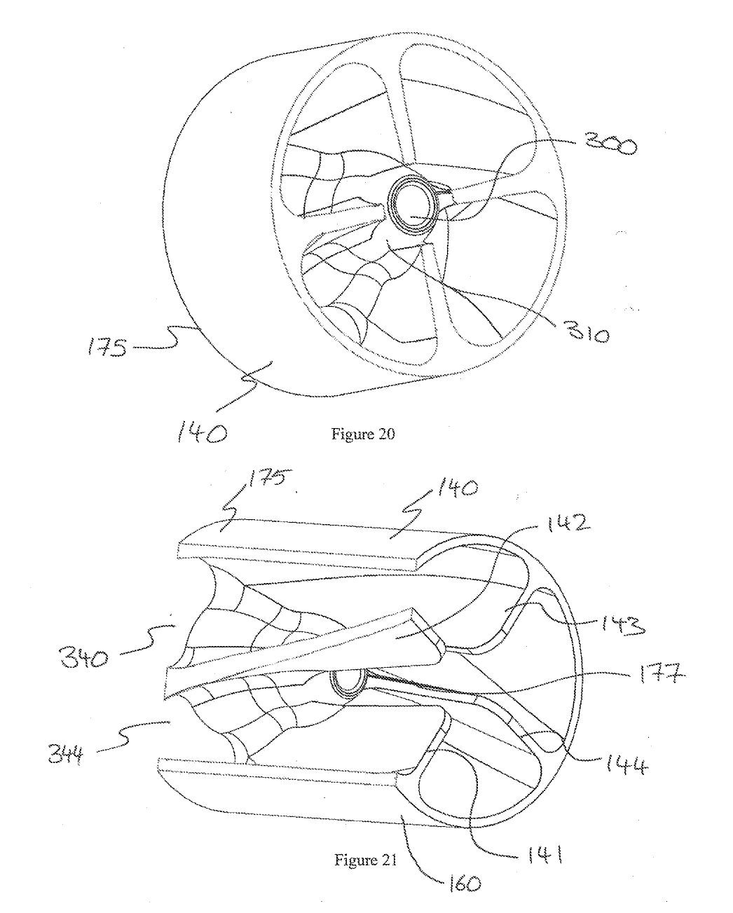

Referring now to FIG. 20, being a cross-sectional view through A-A of FIG. 18, the central hub section 300 has a rearward sloping nose flange 310 which connects to a lower portion of each of the baffles 141-144. FIG. 21, being a cross-section through B-B of FIG. 19, shows the helical twist of the blades/baffles, in particular baffle 142 all the way through the baffle section 140 down towards the opening 340 positioned on the rear end 175.

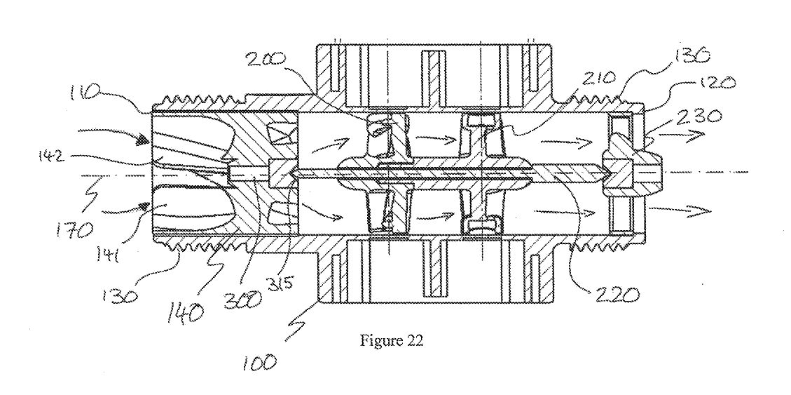

FIG. 22 shows a cross-sectional view of the apparatus as shown in FIG. 15, in particular the baffle section 140.

The apparatus may be integrated into a control system, including sensors and transducers (such as temperature or moisture sensors, salinity or light meters, etc.) for collecting measurable information, at least one processing unit and equipment, such as, but not limited to switches, valves, pumps, and taps, for execution of actions such as watering, battery charging, lighting, and heating. Data may be collected from the apparatus and transmitted to a central processing unit for displaying and monitoring. Executable commands may be sent back to the apparatus. The transfer of the information may utilize wireless transmitters with different protocols. Accordingly the system may include data processing, transmitting system and telemetric control. The skilled addressee will understand the operation of such systems and therefore they will not be discussed in further detail.

The power generating apparatus 10 may be configured to match different pipe line diameter sizes, constructions and types. Different impeller shapes and different stator active coil constructions may be used for different liquid density, viscosity, flow speed and rates and other variable parameters of filled pipe lines.

The apparatus may include a number of modules combined in a single united power generation system. The modules can work separately or in combination with multiple stations in a functionally united system. Each station may have an individual electronic control system or be subordinated to a central control unit.

The power generated by the apparatus 10 has numerous domestic and commercial applications including, but not limited to, facilitate “Time of Use” billing systems, provide an understanding of effects of “Use Demands” on pressure availability, identify and locate leaks, plan for diurnal patterns of water use, assist in overall urban water management, improve efficiency and productivity of on-farm irrigation water use, enable the injection of ozone or fertilizer and/or to radiate UV rays, into the fluid flowing through the conduit. The injection of matter or light into the fluid may be for the purposes of killing bacteria and/or viruses, improving water quality or introducing beneficial substances into the fluid.

The apparatus may also be located within the downpipes of residential or commercial premises to generate electricity to be used onsite, such as to recharge a hybrid vehicle, or can be fed into the power grid. The reader will now appreciate that the apparatus of the present invention has numerous applications, in the domestic, commercial, agricultural, and mining settings, for instance the apparatus may be used in conjunction with ventilation shafts or fluid delivery pipes in mining site or within irrigation systems.

In one example the power generated by the invention could be used in a distributed irrigation and control system including, but not limited to, electrical switches for operating with external electrical devices, water solenoid valves and water solenoid taps for switching water run and water generators, water pumps for controlling water supply pressure, data transmitters for controlling radio/wireless data and parameters exchange, fertilizer control switches, display/monitor controllers for delivery visual information, and external power switches for using additional electrical devices, etc.

The power generated by the systems of the above example may be utilized in various applications including, but not limited to, monitoring, measuring, reporting on: heavy metals levels including arsenic; to provide soil moisture budgets at various locations, and provide power to open/close ‘gates’ to water to appropriate levels in specific areas in a given wider area—thus avoiding overwatering (which can lead to salinity levels rising) and avoiding water wastage; fertilizer requirements of soil in particular areas, and provide power to open/close ‘gates’ to water and ‘feed’ to appropriate levels in specific areas in a given wider area, thus avoiding under/over fertilizing which can lead to poor soil conditions, or less than optimum crops; and trace element requirements of soil in particular areas, and provide power to open/close ‘gates’ to water and ‘feed’ to appropriate levels in specific areas in a given wider area—thus avoiding less than optimum levels of trace elements being added to the soil, thus enhancing soil conditions and likelihood of optimum crops.

The skilled addressee will now appreciate the illustrated invention provides a power generating apparatus that has benefits over the prior art. The invention may be retrofitted to existing fluid conduits or new fluid conduits may be constructed having multiple points therealong that are configured to accommodate a plurality of the power generating apparatus of the present invention. The apparatus may also be provided as a coupling that can be connected at the end of the conduit or intermediate of two portions of a conduit to generate electrical power.

Various features of the invention have been particularly shown and described in connection with the exemplified embodiments of the invention, however, it must be understood that these particular arrangements merely illustrate and that the invention is not limited thereto. Accordingly the invention can include various modifications, which fall within the spirit and scope of the invention. It should be further understood that for the purpose of the specification the word “comprise” or “comprising” means “including but not limited to”.

What is claimed is:

1. An electrical generator comprising:
a coupling, the coupling comprising a tube for connection with a flow path of a fluid conduit,
an impeller comprising blades fixed to a shaft, free ends of the blades carrying magnetic portions, such that said impeller is within said flow path within said fluid conduit,
wherein the shaft aligned with the flow path and is located inside the tube, and wherein a first and second end of the shaft supported relative to an inside surface of the tube by respective first and second mounting elements, and
at least two stators connected to the outside of tube by a mount and aligned with the magnetic portions, such that an electrical current is induced on rotation of the impeller;
wherein said electrical generator includes comprising one or more directional baffles in the flow path upstream of the impeller, said baffles imparting a helical directionality on the fluid flowing there through in the same direction of rotation of said impeller.

2. The generator of claim 1 wherein the impeller comprises two or more sets of blades spaced axially on the shaft.

3. The generator of claim 1 wherein an inside surface of the conduit is rifled to impart helical directionality on the fluid flowing therethrough in the same direction of rotation of the impeller.
